(19) United States
(12) Patent Application Publication
(10) Pub. No.: US 2014/0266214 A1
(43) Pub. Date: Sep. 18, 2014

(54) METHOD AND SYSTEM FOR MONITORING SUBSURFACE INJECTION PROCESSES USING A BOREHOLE ELECTROMAGNETIC SOURCE

(71) Applicants: David Lee Alumbaugh, Berkeley, CA (US); Gary Michael Hoversten, Lafayette, CA (US)

(72) Inventors: David Lee Alumbaugh, Berkeley, CA (US); Gary Michael Hoversten, Lafayette, CA (US)

(73) Assignee: Chevron U.S.A. Inc., San Ramon, CA (US)

(21) Appl. No.: 13/834,338

(22) Filed: Mar. 15, 2013

(51) Int. Cl. G01V 3/26

(52) U.S. Cl. CPC G01V 3/26
USPC 324/355

(57) ABSTRACT

A method and a system for providing electromagnetic measurement in a rock formation are provided. The system includes a borehole casing having a plurality of casing segments. At least two casing segments of the plurality of casing segments are electrically isolated from each other. The system further includes an electromagnetic source positioned on a surface of the earth. The electromagnetic source is connected to the at least two casing segments. The electromagnetic source is configured to energize the at least two casing segments so as to generate an electromagnetic field in the rock formation around the borehole casing.

### FIELD

The present invention pertains to a system and method for providing electromagnetic measurement in a rock formation, for example, for monitoring subsurface injection processes.

### BACKGROUND

Monitoring of reservoir or subsurface injection processes is increasingly used in the petroleum and gas industry. General examples include water flood monitoring whereby water is injected into an oil reservoir to maintain pressure as well as mobilize oil, as well as in the determination of hydro-fracture growth location in conventional and unconventional reservoirs for optimization of well spacing. In one example, an electromagnetically conductive fluid can be used to replace resistive pore fluid (i.e., oil or gas) in the case of the water flood. In another example, a resistive fluid can also be used to replace electromagnetically conductive fluid in the case of CO₂ injection. In yet another example, additional porosity can be created and filled with a conductive fluid in the case of hydro-fracture. In all cases, however, the bulk-rock electromagnetic properties are altered. The fact that bulk-rock electromagnetic properties are altered by the injection of a fluid, make electromagnetic geophysical techniques a natural method for monitoring the progress of injection processes and thus determine where the fluids are diffusing.

A conventional electromagnetic monitoring tool and imaging system called “DeepLook-EM” enhanced electromagnetic (EM) system, commercialized by Schlumberger allows evaluation of the logging resistivity to understand fluid distribution. With the DeepLook-EM tool, a magnetic dipole source is placed in a first well to generate a magnetic field and a magnetic field detector is placed in a second well to measure the magnetic field. Hence, the DeepLook-EM tool is also referred to as a cross-well (i.e., between wells) EM technique. The result of the measurement is either two-dimensional (2D) or three-dimensional (3D) images of resistivity in the region between the first and second wells. The DeepLook-EM tool is useful in water flood monitoring but requires that the first and second non-producing wells be spaced apart with a proper distance and be accessible simultaneously. In addition, the DeepLook-EM tool cannot be used when both wells are cased with standard carbon steel casing which implies that special completions are required. As a result, the DeepLook-EM tool has not seen wide use.

Electromagnetic (EM) measurements from the surface or seafloor have also been investigated as a method for monitoring reservoir production and processes. However, the spatial resolution for this configuration tends to be poor due to the fact that the sensors are located far away from the reservoir.

The limitations of the above two techniques has led to an increased interest in surface-to-borehole (STB) or borehole-to-surface (BTS) techniques which offer the potential of having similar resolution to cross-well techniques near the well bore or borehole, but only use one well at a time. FIG. 1 depicts a schematic representation of a conventional BTS configuration. In this configuration, an electromagnetic source 10 is placed inside borehole 11 within rock formation 12 to generate an electromagnetic field, while one or more electromagnetic detectors or receivers 13 are placed on surface 14 of the earth (i.e., surface of rock formation 12) to measure the electromagnetic field within the rock formation 12.

All techniques to date assume that the well is open, and thus direct contact with the rock formation can be established. However, this may not be the case in many reservoirs. Therefore, a new technique is needed to cure the deficiencies of the above conventional techniques.

### SUMMARY

An aspect of the present invention is to provide a system for providing electromagnetic measurement in a rock formation. The system includes a borehole casing comprising a plurality of casing segments, wherein at least two casing segments of the plurality of casing segments are electrically isolated from each other. The system further includes an electromagnetic source positioned on a surface of the earth, the electromagnetic source being connected to the at least two casing segments, the electromagnetic source being configured to energize the at least two casing segments so as to generate an electromagnetic field in the rock formation around the borehole casing.

Another aspect of the present invention is to provide a method for providing electromagnetic measurement in a rock formation. The method includes disposing a borehole casing in a borehole, the borehole casing having a plurality of casing segments. At least two casing segments of the plurality of casing segments are electrically isolated from each other. The method further includes disposing an electromagnetic source on a surface of the earth, the electromagnetic source being connected to the at least two casing segments; and energizing the at least two casing segments so as to generate an electromagnetic field in the rock formation around the borehole casing.

Although the various steps of the method according to one embodiment of the invention are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 depicts a schematic representation of a conventional borehole-to-surface (BTS) configuration;

FIG. 2 is a simulated contour map of averaged percent change in electromagnetic conductivity (or change in average resistivity) at a depth of about 2485 meters in a rock formation, according to an embodiment of the present invention;

FIG. 3A-3G are simulated contour maps of a horizontal electromagnetic field measured at a plurality of receivers located on a surface of the earth, at various points in time after turning off the electromagnetic source, before injection of CO2 into the rock formation, according to an embodiment of the present invention;

FIG. 4A-4H are simulated contour maps of a horizontal electromagnetic field measured at a plurality of receivers located on a surface of the earth, at various points in time after turning off the electromagnetic source, after injection of CO2 into the rock formation, according to an embodiment of the present invention;

FIG. 5A shows a conventional configuration in a standard borehole completion;

FIGS. 5B-5D depict some of the different casing isolation configurations, according to embodiments of the present invention;

FIGS. 6A-6D depicts various voltage configurations for providing dipole electromagnetic sources within the borehole, according to various embodiments of the present invention; and

FIGS. 7A-7C depicts various configurations for applying a voltage across two casing segments, according to various embodiments of the present invention.

### DETAILED DESCRIPTION

FIG. 2 is a simulated contour map of averaged percent change in electromagnetic conductivity (or change in average resistivity) at a depth of about 2485 meters in a rock formation, according to an embodiment of the present invention. The vertical axis represents the north-south direction and the horizontal axis represents the east-west direction. Also represented on this contour map is a line 20 providing an outline of a CO2 injection region. The various gray-shaded levels in FIG. 2 provide relative amplitude of an electromagnetic signal received by receivers or detectors 22 when the rock formation is subject to an electromagnetic field generated by EM source 24. The receivers 22 are represented by “+” symbols. Each of receivers 22 can be placed at the surface of the rock formation or within a borehole. The EM source 24 is represented in FIG. 2 by the symbol “o”. In one embodiment, the EM source is placed at a depth of about 200 meters within a borehole.

FIG. 3A-3G are simulated contour maps of a horizontal electromagnetic field measured at a plurality of receivers 22 located on a surface of the earth, at various points in time after turning off the electromagnetic source 24, before injection of CO2 into the rock formation, according to an embodiment of the present invention. FIG. 3A is the contour map of the horizontal electromagnetic field received by receivers 22 after 0.01 second of turning off the electromagnetic field of EM source 24. FIG. 3B is the contour map of the horizontal electromagnetic field received by receivers 22 after 0.1 second of turning off the electromagnetic field of EM source 24. FIG. 3C is the contour map of the horizontal electromagnetic field received by receivers 22 after 0.33 second of turning off the electromagnetic field of EM source 24. FIG. 3D is the contour map of the horizontal electromagnetic field received by receivers 22 after 1 second of turning off the electromagnetic field of EM source 24. FIG. 3E is the contour map of the horizontal electromagnetic field received by receivers 22 after 3.3 seconds of turning off the electromagnetic field of EM source 24. FIG. 3F is the contour map of the horizontal electromagnetic field received by receivers 22 after 7 seconds of turning off the electromagnetic field of EM source 24. FIG. 3G is the contour map of the horizontal electromagnetic field received by receivers 22 after 10 seconds of turning off the electromagnetic field of EM source 24. The vertical axis in these contour maps represents north-south direction and the horizontal axis represents the east-west direction. The various shades of gray provide the amplitude of the electromagnetic field (e.g., in V/m) measured by the receivers 22. The “+” signs show the relative position of the receivers 22 and the “o” sign shows the relative position of the EM source 24. Although, the above measurements are performed using receivers placed on the earth surface, the above measurements can also be performed using receivers placed inside one or more boreholes.

As shown in FIGS. 3A-3D, initially, in the time range between about 0.01 second to about 1 second after turning off the EM source, the detected electromagnetic field is essentially centered around and symmetrical relative to the position of the EM source 24. Specifically, the minimum of the electromagnetic field is centered around the position of the EM source 24. However, as shown in FIGS. 3E-3G, in the time range between about 3.3 seconds to about 10 seconds after turning off the EM source 24, the detected electromagnetic field, in particular the minimum of the electromagnetic field, is no longer centered around the location of the EM source 24. The minimum of the detected electromagnetic field drifts or migrates towards the south-west (S-W) corner. Furthermore, the symmetry of the contour lines of the detected electromagnetic field is also broken.

FIG. 4A-4H are simulated contour maps of a horizontal electromagnetic field measured at a plurality of receivers 22 located on a surface of the earth, at various points in time after turning off the electromagnetic source 24, after injection of CO2 into the rock formation, according to an embodiment of the present invention. FIG. 4A is the contour map of the horizontal electromagnetic field received by receivers 22 after 0.01 second of turning off the electromagnetic field of EM source 24. FIG. 4B is the contour map of the horizontal electromagnetic field received by receivers 22 after 0.1 second of turning off the electromagnetic field of EM source 24. FIG. 4C is the contour map of the horizontal electromagnetic field received by receivers 22 after 0.33 second of turning off the electromagnetic field of EM source 24. FIG. 4D is the contour map of the horizontal electromagnetic field received by receivers 22 after 1 second of turning off the electromagnetic field of EM source 24. FIG. 4E is the contour map of the horizontal electromagnetic field received by receivers 22 after 1 second of turning off the electromagnetic field of EM source 24. FIGS. 4D and 4E represent the same data but plotted at a different intensity scale.

FIG. 4F is the contour map of the horizontal electromagnetic field received by receivers 22 after 3.3 second of turning off the electromagnetic field of EM source 24. FIG. 4G is the contour map of the horizontal electromagnetic field received by receivers 22 after 7 seconds of turning off the electromagnetic field of EM source 24. FIG. 4H is the contour map of the horizontal electromagnetic field received by receivers 22 after 10 seconds of turning off the electromagnetic field of EM source 24. The vertical axis in these contour maps represents north-south direction and the horizontal axis represents the east-west direction. The various shades of gray provide the amplitude of the electromagnetic field (e.g., in V/m) measured by the receivers 22.

The “+” signs show the relative position of the receivers 22 and the “o” sign shows the relative position of the EM source 24. Although, the above measurements are performed using receivers placed on the earth surface, the above measurements can also be performed using receivers placed inside one or more boreholes. These contour maps represent the percent change of the electromagnetic field from the electromagnetic field measured at base level before CO2 injection and the electromagnetic field obtained about 49 years after CO2 injection.

As shown in FIGS. 4A-4D, initially, in the time range between about 0.01 second to about 1 second after turning off the EM source, the percent change in the detected electromagnetic field is essentially flat, meaning that in this time frame the electromagnetic field does not exhibit a variation from before CO2 injection and after CO2 injection. However, as shown in FIGS. 4E-4H, in the time range between about 1 second and about 10 seconds, the percent change in the detected electromagnetic field between the electromagnetic field before CO2 injection and the electromagnetic field after injection is clearly visible. For example, in the time frame of 1 second after turning off the EM source 24, the percent change in the detected electromagnetic field is in the order of about 10%. The percent change in the detected electromagnetic field increases with the time elapsed after turning off the EM source 24. For example, at 10 seconds after turning off the EM source 24, the percent change reaches almost 100 percent. In addition, as it can be noted in FIG. 4F-4H, the percent change in the detected electromagnetic field becomes also asymmetric with the maximum in the percent change of the detected electromagnetic field migrating towards the south-west (S-W). The above simulations are performed using a 3D finite package from Lawrence Berkeley National Laboratory.

In order to perform the above electromagnetic field measurements in a real setting, a system and method for modifying a standard borehole completion with steel casing having electromagnetic isolation regions is provided herein wherein an electromagnetic source (e.g., an electric source) is either permanently installed within the well or accessed by a wireline tool.

FIG. 5A shows a conventional configuration in a standard borehole completion. As shown in FIG. 5A, casing 50A includes a plurality of casing segments 52A that are joined via steel-to-steel casing joints 54A. Casing joints 54A are not electrically isolated. FIGS. 5B-5D depict some of different casing isolation configurations, according to embodiments of the present invention. FIG. 5B shows a configuration with a single gap completion, according to an embodiment of the present invention. As shown in FIG. 5B, casing 50B includes a plurality of casing segments 52B that are joined via steel-to-steel casing joints 54B. Casing joints 54B are not electrically isolated. Casing 50B also includes joint 56B between two casing segments 53B. Casing joint 56B electrically isolates two adjacent casing segments 53B.

FIGS. 5C and 5D show borehole completion configurations with dual gap and triple gap, according to embodiments of the present invention. As shown in FIG. 5C, casing 50C includes a plurality of casing segments 52C that are joined via steel-to-steel casing joints 54C. Casing joints 54C are not electrically isolated. Casing 50C also includes two joints 56C between three casing segments 53C. Joints 56C electrically isolate adjacent casing segments 53C. As shown in FIG. 5D, casing 50D includes a plurality of casing segments 52D that are joined via steel-to-steel casing joints 54D. Casing joints 54D are not isolated. Casing 50D also includes joints 56D between four casing segments 53D. Joint 56D electrically isolates the casing segments 53D.

In one embodiment, isolating joints 56B, 56C and 56D may be made of an electrically isolating material such as, for example fiberglass. In another embodiment, isolation of two joining casing segments 53B, 53C, or 53D can be provided by coating with an electromagnetic resistive ceramic material prior to connecting the ends of the segments 53B, 53C, 53D where two casing segments 53B, 53C, 53D are joined.

The dual and triple gap completions (i.e., with two or more isolation casing joints) provide an increased “electromagnetic dipole” source with the increasing number of isolating gaps or joints. The presence of the isolation joints or gaps 56C and 56D in casing 50C and 50D force the current out into the formation and fluid within the casing. This provides a farther penetration of the electromagnetic field into the rock formation surrounding the borehole or casing (e.g., casing 50C and 50D). Otherwise, the current can simply short circuit along the electromagnetically conductive casing. If the current short circuits along the electromagnetically conductive casing, such as is the case in casing 50A, there would be reduced ability to monitor away from the borehole because the current does not flow through the rock formation. Therefore, any measurements of electromagnetic fields without providing the isolating joints or gaps (e.g., 56C, 56D) will be primarily measuring properties of the casing.

FIGS. 6A-6D depicts various voltage configurations for providing dipole electromagnetic sources within the borehole, according to various embodiments of the present invention. FIG. 6A depicts a configuration in which a voltage V is applied between two adjacent casing segments 62A in casing 60A, the casing segments 62A being electrically isolated by isolation joint or gap 63A. The casing 60A has only a single gap or isolated joint 63A. FIG. 6B depicts a configuration in which a voltage V is applied between two adjacent casing segments 62B in casing 60B, the casing segments 62B being electrically isolated by isolation joint or gap 63B. The casing 60B has dual gap or dual isolated joints 63B but a voltage is only applied to two casing segments 62B between a single isolation joint or gap 63B. FIG. 6C depicts a configuration in which a voltage V is applied between two casing segments 62C in casing 60C, the casing segments 62C being electrically isolated by two isolation joints or gaps 63C. The casing 60C has dual gap or dual isolated joints 63C and a voltage V is applied two casing segments 62C separated by isolation joints or gaps 63C and one casing segment 64C. Casing segments 63B is not connected to a voltage source. FIG. 6D depicts a configuration in which a voltage V is applied between two casing segments 62D in casing 60D, the casing segments 62D being electrically isolated by two isolation joints or gaps 63D. The casing 60C has triple gaps or triple isolated joints 63C but a voltage V is applied to only two casing segments 62D separated by two isolation joints or gaps 63D and one casing segment 64D. Casing segment 64D is not connected to a voltage source.

As it can be appreciated, the larger the gap between two ends of the voltage source V (i.e., two electrically isolated casing segments), the greater the amount of current that is forced out into the medium or rock formation, especially if at least two isolation gaps fall between the two voltage connection points. For example, in the case of casing 60C which is provided with a voltage applied between two casing segments 62C separated by two isolation joints or gaps 63C, the voltage applied across the two casing segments 62C creates a greater amount of electromagnetic field that is forced out into the rock formation than in the case of the casing 60B which is only provided with a voltage applied between two segments 62B separated by a single isolation joint or gap 63B.

FIGS. 7A-7C depicts various configurations for applying a voltage across two casing segments, according to various embodiments of the present invention. FIG. 7A depicts a configuration in which a voltage V generated by voltage source 71A is applied between two casing segments 72A in casing 70A, the casing segments 72A being electrically isolated by two isolation joints or gaps 73A. The casing 70A has dual gap or dual isolated joints 73A and a voltage V is applied across two casing segments 72A separated by isolation joints or gaps 73A and one casing segment 74A. Casing 74A is not connected to the voltage source 71A. The electrical voltage or electrical power is delivered to the casing segments 72A using electrical lines 75A that are run outside the casing 70A. In one embodiment, the voltage source 71A is placed at a surface of the earth. The term surface of earth is used herein broadly to include a surface of a sea or ocean.

FIG. 7B depicts a configuration in which a voltage V generated by voltage source 71B is applied between two casing segments 72B in casing 70B, the casing segments 72B being electrically isolated by two isolation joints or gaps 73B. The casing 70B has dual gap or dual isolated joints 73B and a voltage V is applied across two casing segments 72B separated by isolation joints or gaps 73B and one casing segment 74B. Casing segments 74B is not connected to the voltage source 71B. The electrical voltage or electrical power is delivered to the casing segments 72B using electrical lines 75B that are run inside the casing 70A. The electrical lines 75A and 75B are permanently attached to the respective casing segments 72A, 72B. In one embodiment, the voltage source 71B is placed at a surface of the earth.

FIG. 7C depicts a configuration in which a voltage V generated by voltage source 71C is applied between two casing segments 72C in casing 70C, the casing segments 72C being electrically isolated by two isolation joints or gaps 73C. The casing 70C has dual gap or dual isolated joints 73C and a voltage V is applied across two casing segments 72C separated by isolation joints or gaps 73C and one casing segment 74C. The electrical voltage or electrical power from source 71C is delivered to the casing segments using a wireline tool 75C. The wireline tool 75C is configured to be deployed within the borehole or casing 70C when desired. The wireline tool 75C comprises an electrical line 76C and a plurality of spaced apart electrical connectors (e.g., arms) 77C. The wireline tool 75C can be deployed within the casing 70C, lowered into place, and then the connectors (e.g., arms) 77C expanded to make contact with the casing. In one embodiment, the voltage source 71C is placed at a surface of the earth. The wireline tool 75C is deployable inside the casing 70C so that the spaced apart electrical connectors 77C connect with the casing segments 72C. The electrical connectors 77C are spaced apart such that a first electrical connector 77C 1 connects with a first segment 72C1 and a second electrical connector 77C2 connects with a second segment 72C2.

In one embodiment, the various casing segments can be energized by using, for example, a power of about 10 kW while delivering a current of about 100 Amps to selected casing segments. As it can be appreciated, the power can be varied according to the type of electrical isolation used, to the thickness of the isolation used, or to the desired penetration of the electromagnetic field into the rock formation. By providing the voltage source 71A, 71B, 71C at the earth surface, a higher power voltage source can be used to provide the desired energy to the casing segments 772A, 72B, 72C, respectively. As a result, a stronger electromagnetic field can be generated within the rock formation that can penetrate deep into the rock formation away from the casing 70A, 70B, 70C.

As it can be appreciated from the above paragraph, in one embodiment, a method for providing electromagnetic measurement in a rock formation is provided. The method includes disposing a borehole casing in a borehole, the borehole casing having a plurality of casing segments. At least two casing segments of the plurality of casing segments are electrically isolated from each other. The method further includes disposing an electromagnetic source on a surface of the earth, the electromagnetic source being connected to the at least two casing segments; and energizing the at least two casing segments so as to generate an electromagnetic field in the rock formation around the borehole casing. In one embodiment, the method further includes electrically isolating the at least two casing segments with an electrical isolation material disposed between the at least two casing segments. For example, the isolating may include coating ends of the at least two casing segments with a resistive ceramic material. In one embodiment, the method further includes connecting electrical wires to the at least two casing segments to provide electrical energy to the at least two casing segments.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A system for providing electromagnetic measurement in a rock formation, comprising:
a borehole casing comprising a plurality of casing segments, wherein at least two casing segments of the plurality of casing segments are electrically isolated from each other; and
an electromagnetic source positioned on a surface of the earth, the electromagnetic source being connected to the at least two casing segments, the electromagnetic source being configured to energize the at least two casing segments so as to generate an electromagnetic field in the rock formation around the borehole casing.

2. The system according to claim 1, further comprising an electrical isolation material disposed between the at least two casing segments where the at least two casing segments are joined to electrically isolate the at least two casing segments.

3. The system according to claim 2, wherein the isolation material includes fiber glass or a resistive ceramic material.

4. The system according to claim 3, wherein the resistive ceramic material is coated on joined ends of the at least two casing segments.

5. The system according to claim 2, wherein the at least two casing segments are separated by the electrical isolation material and at least one casing segment that is not connected to the electromagnetic source so as to provide a wider gap between electrical connections of the at least two casing segments.

6. The system according to claim 2, wherein the at least two casing segments are separated by two isolation joints and at least one casing segment that is not connected to the electromagnetic source so as to provide a wider gap between electrical connections of the at least two casing segments.

7. The system according to claim 1, further comprising electrical wires configured to provide electrical energy to the at least two casing segments.

8. The system according to claim 7, wherein the electrical wires are provided outside the casing.

9. The system according to claim 7, wherein the electrical wires are provided inside the casing.

10. The system according to claim 1, further comprising a wireline tool including an electrical line and a plurality of spaced apart electrical connectors, the wireline tool being configured to provide electrical energy to the at least two casing segments.

11. The system according to claim 10, wherein the wireline tool is deployable inside the casing so that the spaced apart electrical connectors connect with the at least two casing segments.

12. The system according to claim 10, wherein the plurality of spaced apart electrical connectors are spaced apart such that a first electrical connector connects with a first segment of the at least two casing segments and a second electrical connector connects with a second segment of the at least two casing segments.

13. A method for providing electromagnetic measurement in a rock formation, comprising:
disposing a borehole casing in a borehole, the borehole casing comprising a plurality of casing segments, wherein at least two casing segments of the plurality of casing segments are electrically isolated from each other; and
disposing an electromagnetic source on a surface of the earth, the electromagnetic source being connected to the at least two casing segments; and
energizing the at least two casing segments so as to generate an electromagnetic field in the rock formation around the borehole casing.

14. The method according to claim 13, further comprising electrically isolating the at least two casing segments with an electrical isolation material disposed between the at least two casing segments.

15. The method according to claim 14, wherein isolating comprises coating ends of the at least two casing segments with a resistive ceramic material.

16. The method according to claim 13, further comprising connecting electrical wires to the at least two casing segments to provide electrical energy to the at least two casing segments.
